(19) United States
(12) Patent Application Publication
(10) Pub. No.: US 2025/0158440 A1
(43) Pub. Date: May 15, 2025

(54) POWER ADAPTER FOR SUPPLYING POWER TO ELECTRONIC DEVICE

(71) Applicant: Power Forest Technology Corporation, Hsinchu County (TW)

(72) Inventor: Kuo Min Hsu, Taoyuan City (TW)

(73) Assignee: Power Forest Technology Corporation, Hsinchu County (TW)

(21) Appl. No.: 18/544,438

(22) Filed: Dec. 19, 2023

(30) Foreign Application Priority Data
Nov. 15, 2023 (TW) 112144015

(51) Int. Cl. H02J 7/00

(52) U.S. Cl. CPC H02J 7/007188; H02J 7/0049; H02J 7/007182; H02J 2207/20; H02J 2310/52

(57) ABSTRACT

Disclosed is a power adapter for supplying power to an electronic device. The power adapter includes a power conversion circuit and a control circuit. The power conversion circuit receives an input power. The control circuit communicates with the electronic device to obtain a power requirement of the electronic device. When the electronic device is connected to the power adapter and the electronic device requests power supply, the control circuit uses a first switching frequency to control the power switch so that the power conversion circuit converts the input power into a first output power. When the power requirement from the electronic device is not received, the control circuit uses a second switching frequency to control the power switch so that the power conversion circuit converts the input power into a second output power. The second switching frequency is lower than the first switching frequency.

### CROSS-REFERENCE TO RELATED APPLICATION

This application claims the priority benefit of Taiwan application serial no. 112144015, filed on Nov. 15, 2023. The entirety of the above-mentioned patent application is hereby incorporated by reference herein and made a part of this specification.

### BACKGROUND

### Technical Field

The present disclosure relates to a power adapter, and in particular, to a power adapter that supplies power to an electronic device.

### Description of Related Art

Generally speaking, a power adapter receives input power and supplies output power based on the input power. Once the power adapter is connected to the electronic device, the power adapter will supply power to the electronic device according to the power requirement of the electronic device.

However, for the need of saving power, when the electronic device is in a sleep state or the electronic device is not connected to another electronic device, the power adapter does not receive the power requirement from the electronic device. Therefore, the power adapter will be required to reduce power consumption and continuously supply output power. It can be seen from the above that when no power requirement is received, how to reduce power consumption while continuously supplying output power by the power adapter is one of the issues for those skilled in the art to deal with.

### SUMMARY

The present disclosure provides a power adapter for supplying power to electronic devices. When no power requirement is received, the power adapter may effectively reduce power consumption while continuously supplying output power.

A power adapter of the disclosure includes a power conversion circuit and a control circuit. The power conversion circuit receives an input power. The power conversion circuit includes a power switch. The control circuit is coupled to the power conversion circuit. The control circuit communicates with the electronic device to obtain a power requirement of the electronic device. When the electronic device is connected to the power adapter and the electronic device requests power supply, the control circuit uses a first switching frequency to control the power switch so that the power conversion circuit converts the input power into a first output power. When the power requirement from the electronic device is not received, the control circuit uses a second switching frequency to control the power switch so that the power conversion circuit converts the input power into a second output power. The second switching frequency is lower than the first switching frequency.

Based on the above, when the power requirement of the electronic device is not received, the control circuit reduces the switching frequency to control the power switch. Therefore, when the power requirement of the electronic device is not received, the switching energy loss in the switching state of the power switch may be greatly reduced. In this way, when no power requirement is received, the power adapter may effectively reduce power consumption while continuously supplying output power.

### BRIEF DESCRIPTION OF THE DRAWINGS

FIG. 1 is a schematic view of a power adapter according to an embodiment of the present disclosure.

FIG. 2 is a schematic view of an operation according to an embodiment of the present disclosure.

FIG. 3 is a voltage waveform diagram of the first output power and the second output power according to an embodiment of the present disclosure.

FIG. 4 is a schematic circuit diagram of a power adapter according to an embodiment of the present disclosure.

### DESCRIPTION OF THE EMBODIMENTS

Some embodiments of the present disclosure will be described in detail with reference to the accompanying drawings. The reference symbols cited in the following description will be regarded as the same or similar components when the same reference symbols appear in different drawings. These embodiments are only part of the present disclosure and do not disclose all possible implementations of the present disclosure. Rather, these embodiments are only examples within the scope of claims of the disclosure.

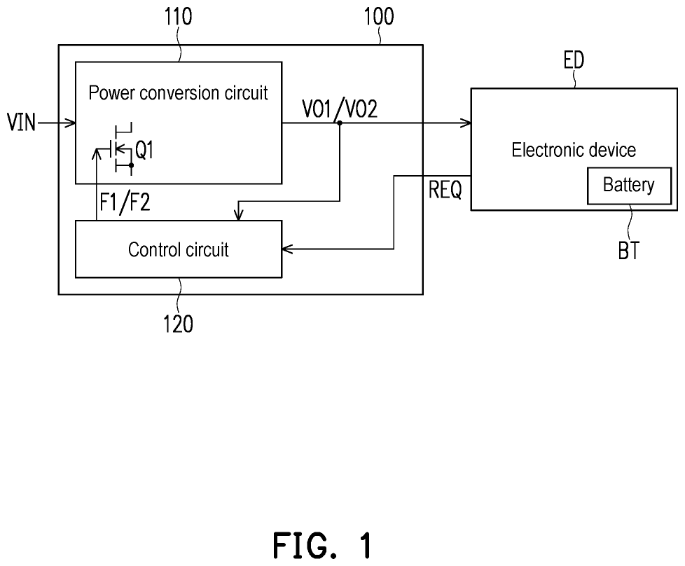

Please refer to FIG. 1. FIG. 1 is a schematic view of a power adapter according to an embodiment of the present disclosure. In this embodiment, the power adapter 100 is configured to supply power to the electronic device ED. The power adapter 100 includes a power conversion circuit 110 and a control circuit 120. The power conversion circuit 110 receives input power VIN. The power conversion circuit 110 includes a power switch Q1. The power conversion circuit 110 may operate based on switching of the switching state of the power switch Q1 to convert the input power VIN into one of the first output power VO1 and the second output power VO2.

In this embodiment, the control circuit 120 is coupled to the power conversion circuit 110. The control circuit 120 communicates with the electronic device ED to obtain the power requirement REQ from the electronic device ED. The power requirement REQ may be a signal or a status value (such as a voltage value). When the electronic device ED is connected to the power adapter 100 and the electronic device ED sends the power requirement REQ, the control circuit 120 receives the power requirement REQ and controls the power switch Q1 using the first switching frequency F1. Therefore, the power conversion circuit 110 converts the input power

VIN into the first output power VO1. In other words, the power switch Q1 switches the switching state based on the first switching frequency F1, so that the power conversion circuit 110 will provide the first output power VO1 and supply power to the electronic device ED.

In this embodiment, when the power requirement REQ of the electronic device ED is not received, the control circuit 120 uses the second switching frequency F2 to control the power switch Q1. Therefore, the power conversion circuit 110 converts the input power VIN into the second output power VO2. In this embodiment, the second switching frequency F2 is lower than the first switching frequency F1.

It is worth mentioning here that when the power requirement REQ of the electronic device ED is not received, the control circuit 120 reduces the switching frequency to control the power switch Q1. Therefore, when the power requirement REQ of the electronic device ED is not received, the switching energy loss in the switching state of the power switch Q1 may be significantly reduced. In this way, when the power requirement REQ is not received, the power adapter 100 may effectively reduce power consumption while continuously providing output power (i.e., the second output power VO2).

In this embodiment, the electronic device ED may be a wearable device, a mobile phone, a notebook computer, a tablet computer, or other devices (but the disclosure is not limited thereto). The power conversion circuit 110 may be any type of flyback converter, LLC converter, boost converter or buck converter (but the disclosure is not limited thereto).

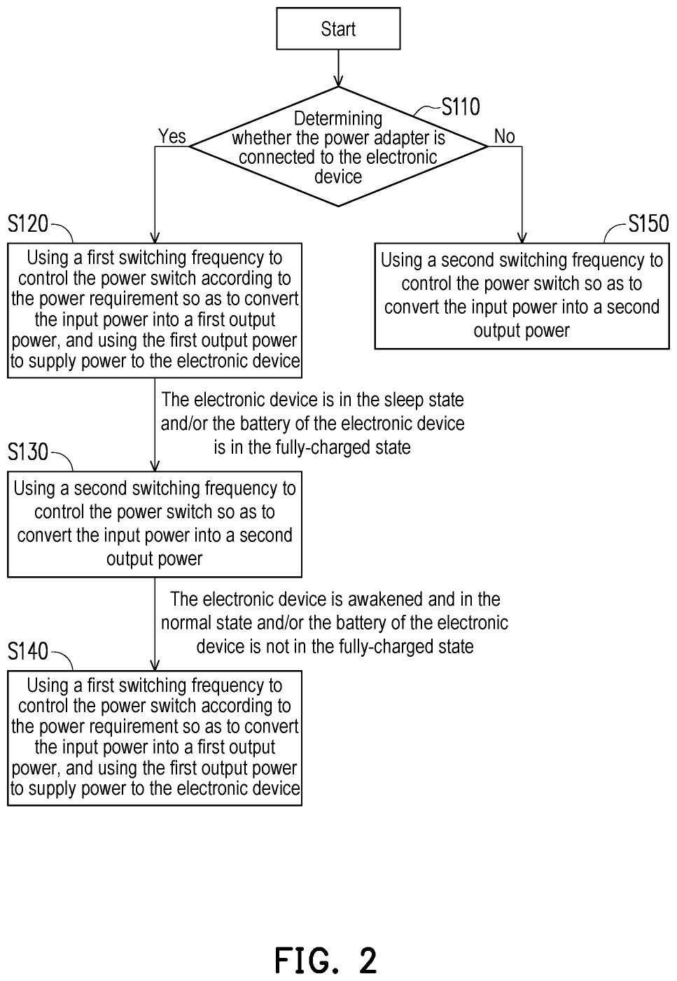

Please refer to FIG. 1 and FIG. 2 at the same time. FIG. 2 is a schematic view of an operation according to an embodiment of the present disclosure. In this embodiment, the power adapter 100 may, for example, use USB TYPE-C to communicate with the electronic device ED and supply power to the electronic device ED. In step S110, the power adapter 100 determines whether the power adapter 100 is connected to the electronic device ED. When the electronic device ED is connected to the power adapter 100 and the electronic device ED is in a normal state, the electronic device ED will send a power requirement REQ. Therefore, the control circuit 120 controls the power switch Q1 using the first switching frequency F1 in step S120. The power conversion circuit 110 converts the input power VIN into the first output power VO1. The power conversion circuit 110 uses the first output power VO1 to supply power to the electronic device ED.

In step S130, when the electronic device ED is connected to the power adapter 100 and the electronic device ED is in a sleep state, the electronic device ED does not send the power requirement REQ. The control circuit 120 uses the second switching frequency F2 to control the power switch Q1. Therefore, the power conversion circuit 110 converts the input power VIN into the second output power VO2.

Also in step S130, when the electronic device ED is connected to the power adapter 100 and the battery BT of the electronic device ED is in a fully charged state, the electronic device ED will not send the power requirement REQ. The control circuit 120 uses the second switching frequency F2 to control the power switch Q1. Therefore, the power conversion circuit 110 converts the input power VIN into the second output power VO2.

In step S140, when the electronic device ED is awakened and is in a normal state and/or the battery BT of the electronic device ED is not in a fully charged state, the electronic device ED will send a power requirement REQ. The control circuit 120 controls the power switch Q1 using the first switching frequency F1. Therefore, the power conversion circuit 110 converts the input power VIN into the first output power VO1.

Therefore, when the power requirement REQ is not received, the power conversion circuit 110 provides the second output power VO2 based on the second switching frequency F2. Once the power requirement REQ is received, the power conversion circuit 110 provides the first output power VO1 based on the first switching frequency F1. Once the power requirement REQ is received, the power conversion circuit 110 changes the second output power VO2 into the first output power VO1. Therefore, the power conversion circuit 110 does not require additional time length for voltage rise. The power conversion circuit 110 may instantly output the first output power VO1.

In step S110, when the electronic device ED is not connected to the power adapter 100, the power adapter 100 does not receive the power requirement REQ of the electronic device ED. Therefore, the control circuit 120 uses the second switching frequency F2 to control the power switch Q1 in step S150. Therefore, the power conversion circuit 110 converts the input power VIN into the second output power VO2.

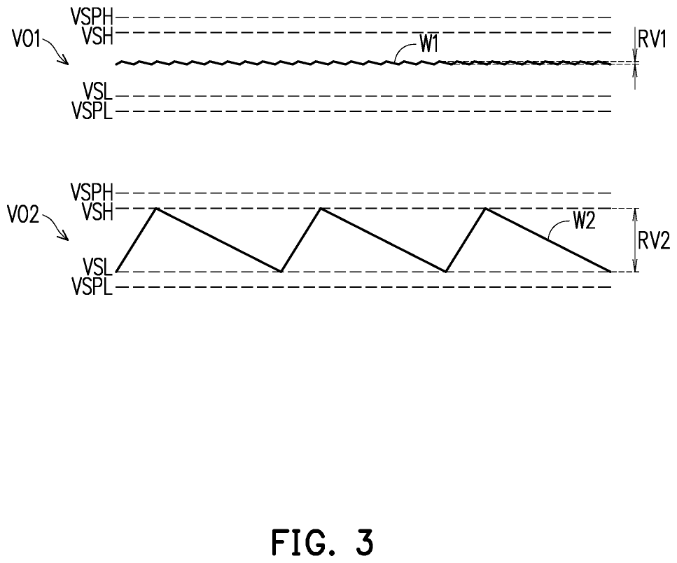

Please refer to FIG. 1 and FIG. 3 at the same time. FIG. 3 is a voltage waveform diagram of the first output power and the second output power according to an embodiment of the present disclosure. FIG. 3 shows the voltage waveform W1 of the first output power VO1 and the voltage waveform W2 of the second output power VO2. In this embodiment, based on the first switching frequency F1, the voltage waveform W1 of the first output power VO1 has a first voltage ripple. In other words, the voltage waveform W1 has a ripple fluctuation RV1 of the first switching frequency F1. Based on the second switching frequency F2, the voltage waveform W2 of the second output power VO2 has a second voltage ripple. In other words, the voltage waveform W2 has a ripple fluctuation RV2 of the second switching frequency F2.

In this embodiment, the ripple fluctuation RV2 of the second voltage ripple is greater than the ripple fluctuation RV1 of the first voltage ripple.

Furthermore, when connected to a specific load (e.g., medium load, heavy load), the power conversion circuit 110 provides the first output power VO1. Based on the first switching frequency F1, the voltage waveform W1 of the first output power VO1 has extremely a small ripple fluctuation RV1. In the case where there is light load or no load, the power conversion circuit 110 provides the second output power VO2. Based on the second switching frequency F2, the voltage waveform W2 of the second output power VO2 has a large ripple fluctuation RV2.

It should be noted that the voltage waveform W1 and the voltage waveform W2 are controlled between a high standard voltage value VSPH and a low standard voltage value VSPL. The high standard voltage value VSPH and the low standard voltage value VSPL are standard voltage values set by the industry.

In this embodiment, the set peak value VSH and the set valley value VSL of the second voltage ripple in the voltage waveform W2 are set. The set peak value VSH of the second voltage ripple is lower than the high standard voltage value VSPH and higher than the peak value of the first voltage ripple. The set valley value VSL of the second voltage ripple is higher than the low standard voltage value VSPL and lower than the valley value of the first voltage ripple. The peak value VSH is set to be slightly lower than the high standard voltage value VSPH. The valley value VSL is set to be slightly higher than the low standard voltage value VSPL. Therefore, although the second voltage ripple in the voltage waveform W2 has a larger ripple fluctuation RV2, the second voltage ripple is still controlled within the high standard voltage value VSPH and the low standard voltage value VSPL.

In this embodiment, the control circuit 120 receives the second output power VO2. When the voltage value of the second output power VO2 rises to the set peak value VSH, the control circuit 120 controls the power switch Q1 to be in the first switching state. Therefore, the voltage value of the second output power VO2 starts to decrease from the set peak value VSH. For example, when the voltage value of the second output power VO2 rises to the set peak value VSH, the control circuit 120 turns on (or turns off) the power switch Q1. When the voltage value of the second output power VO2 drops to the set valley value VSL, the control circuit 120 controls the power switch Q1 to be in the second switching state. The second switching state is opposite to the first switching state. Therefore, the voltage value of the second output power VO2 starts to rise from the set valley value VSL. For example, when the voltage value of the second output power VO2 drops to the set valley value VSL, the control circuit 120 turns off (or turns on) the power switch Q1. Therefore, the ripple fluctuation RV2 in the voltage waveform W2 of the second output power VO2 is equal to the set difference between the set peak value VSH and the set valley value VSL. In addition, the duty cycle of the control signal for controlling the power switch Q1 may be determined by the rising time of the voltage value of the second output power VO2 and the falling time of the voltage value of the second output power VO2.

It can be seen that the second switching frequency F2 is associated with the set peak value VSH and the set valley value VSL that are set. The smaller the set difference between the set peak value VSH and the set valley value VSL, the smaller the second voltage ripple in the voltage waveform W2, and the higher the second switching frequency F2. The larger the set difference between the set peak value VSH and the set valley value VSL, the larger the second voltage ripple in the voltage waveform W2, and the lower the second switching frequency F2. The lower the second switching frequency F2, the lower the switching energy loss in the switching state of the power switch Q1.

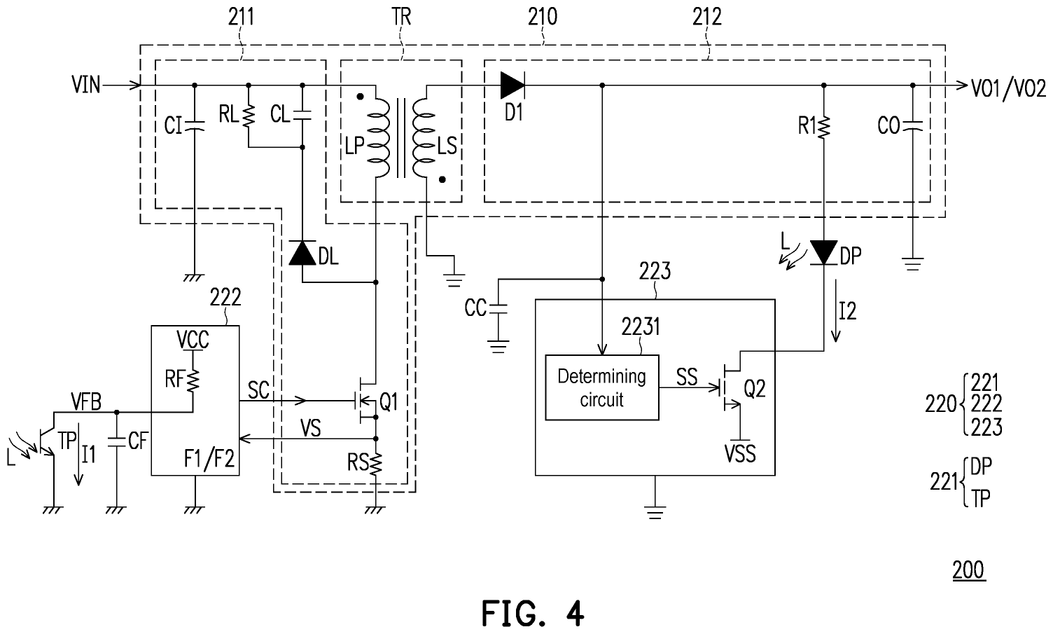

Please refer to FIG. 4. FIG. 4 is a schematic circuit diagram of a power adapter according to an embodiment of the present disclosure. In this embodiment, the power adapter 200 includes a power conversion circuit 210 and a control circuit 220. The power conversion circuit 210 includes a transformer TR, a primary side circuit 211 and a secondary side circuit 212. The primary side circuit 211 is coupled to a primary side winding LP of the transformer TR. The primary side circuit 211 includes a power switch Q1. The secondary side circuit 212 is coupled to the secondary side winding LS of the transformer TR.

The control circuit 220 includes an optical coupling circuit 221, a primary side controller 222 and a secondary side controller 223. The optical coupling circuit 221 is controlled to provide an optical signal L, and to provide an operating current I1 according to the optical signal L.

The secondary side controller 223 is coupled to the secondary side circuit 212 and the optical coupling circuit 221. The secondary side controller 223 controls the optical signal L provided by the optical coupling circuit 221 according to the voltage value of one of the first output power VO1 and the second output power VO2. The primary side controller 222 is coupled to the power switch Q1 and the optical coupling circuit 221. The primary side controller 222 controls the power switch Q1 according to the operating current I1.

Further, taking this embodiment as an example, the primary side circuit 211 further includes capacitors CI and CL, resistors RS and RL and a diode DL. The first terminal of the capacitor CI is coupled to the input terminal of the primary side circuit 211 and the first terminal (or the same end) of the primary side winding LP. The second terminal of the capacitor CI is coupled to the ground terminal corresponding to the primary side circuit 211. The first terminal of the power switch Q1 is coupled to the second terminal (or called the opposite terminal) of the primary side winding LP. The control terminal of the power switch Q1 is coupled to the primary side controller 222. The resistor RS is coupled between the second terminal of the power switch Q1 and the ground terminal corresponding to the primary side circuit 211. The anode of the diode DL is coupled to the second terminal of the primary side winding LP. The resistor RL is coupled between the first terminal of the primary side winding LP and the cathode of the diode DL. The capacitor CL is coupled between the first terminal of the primary side winding LP and the cathode of the diode DL.

The capacitor CL, the resistor RL and the diode DL may jointly form a leakage inductance absorption circuit of the primary side circuit 211. When the power switch Q1 is turned off, the capacitor CL, the resistor RL and the diode DL absorb the leakage inductance from the transformer TR. Therefore, the stress damage caused by the leakage inductance of the power switch Q1 may be reduced. The service life of the power switch Q1 may be improved accordingly.

The first terminal (or the same terminal) of the secondary side winding LS is coupled to the ground terminal corresponding to the secondary side circuit 212. The secondary side circuit 212 includes a rectifier diode D1, a capacitor CO, and a resistor R1. The anode of the rectifier diode D1 is coupled to the second terminal (or the opposite terminal) of the secondary side winding LS. The cathode of the rectifier diode D1 is coupled to the output terminal of the secondary side circuit 212. The capacitor CO is coupled between the output terminal of the secondary side circuit 212 and the ground terminal corresponding to the secondary side circuit 212.

The optical coupling circuit 221 includes a light emitting diode DP and a phototransistor TP. The anode of the light emitting diode DP is coupled to the output terminal of the secondary side circuit 212 through the resistor R1. The cathode of the light emitting diode DP is coupled to the secondary side controller 223. The first terminal of the phototransistor TP is coupled to the primary side controller 222. The second terminal of the phototransistor TP is coupled to the ground terminal corresponding to the primary side circuit 211. The control terminal of the phototransistor TP receives the optical signal L provided by the light emitting diode DP, and generates the operating current I1 according to the optical signal L.

In this embodiment, the load of the power adapter 200 may be determined based on the power requirement (e.g., power requirement REQ as shown in FIG. 1). When the power requirement is received, the load of the power adapter 200 is greater than or equal to the predetermined load. In other words, the power adapter 200 is in a medium load state or a heavy load state. Therefore, when the load of the power adapter 200 is greater than or equal to the predetermined load, the determining circuit 2231 uses the operating signal SS to control the optical coupling circuit 221 to provide the operating current I1 with the first operating current value. The primary side controller 222 controls the power switch Q1 using the first switching frequency F1 in response to the first operating current value.

When no power requirement is received, the load of the power adapter 200 is less than the predetermined load. In other words, the power adapter 200 is in a lightly loaded state. Therefore, when the load of the power adapter 200 is less than the predetermined load, the determining circuit 2231 uses the operating signal SS to control the optical coupling circuit 221 to provide the operating current I1 with the second operating current value. The primary side controller 222 controls the power switch Q1 using the second switching frequency F2 in response to the second operating current value.

In this embodiment, the secondary side controller 223 includes a determining circuit 2231 and a control switch Q2. The determining circuit 2231 provides the operating signal SS according to the load status of the power adapter 200. The first terminal of the control switch Q2 is coupled to the optical coupling circuit 221. The second terminal of the control switch Q2 is coupled to the rise time of the voltage value of the second output power VO2 of the reference low voltage VSS. The control terminal of the control switch Q2 receives the operating signal SS.

The control switch Q2 in this embodiment is implemented by, for example, an N-type field effect transistor (FET), but the disclosure is not limited thereto. In some embodiments, the control switch Q2 may be implemented by an NPN-type bipolar transistor (BJT).

The primary side controller 222 includes a resistor RF. The resistor RF is coupled between the reference high voltage VCC and the first terminal of the phototransistor TP. In addition, a capacitor CF is provided. The capacitor CF is coupled between the first terminal of the phototransistor TP and the ground terminal corresponding to the primary side circuit 211.

Taking this embodiment as an example, when the load of the power adapter 200 is greater than or equal to the predetermined load, the output current value at the output terminal of the secondary side circuit 212 will increase. The output voltage value at the output terminal of the secondary side circuit 212 will decrease. Therefore, the voltage value of the operating signal SS provided by the determining circuit 2231 will decrease. The on-resistance of the control switch Q2 increases, thereby causing the current value of the current I2 flowing through the light emitting diode DP to decrease. Therefore, the intensity of the optical signal L also decreases. The current value of the operating current I1 flowing through the phototransistor TP will drop to the first operating current value. Therefore, the feedback voltage VFB located at the first terminal of the phototransistor TP may be charged to a higher first voltage level. Therefore, the primary side controller 222 provides the control signal SC having the first switching frequency F1 in response to the feedback voltage VFB having the first voltage level. The primary side controller 222 controls the power switch Q1 using the control signal SC having the first switching frequency F1. Accordingly, the power conversion circuit 210 converts the input power VIN into the first output power VO1. Moreover, the primary side controller 222 receives the sensing voltage value VS located at the second terminal of the power switch Q1. The sensing voltage value VS will be related to the state of the first output power VO1. The primary side controller 222 will fine-tune the first switching frequency F1, the duty cycle of the control signal SC and/or the voltage value of the feedback voltage VFB according to the sensing voltage value VS.

When the load of the power adapter 200 is less than the predetermined load, the output current value at the output terminal of the secondary side circuit 212 will decrease. The output voltage value at the output terminal of the secondary side circuit 212 will increase. Therefore, the voltage value of the operating signal SS provided by the determining circuit 2231 will increase. The on-resistance of the control switch Q2 is reduced, thereby increasing the current value of the current I2 flowing through the light emitting diode DP. Therefore, the intensity of the optical signal L also increases. The current value of the operating current I1 flowing through the phototransistor TP will rise to the second operating current value. Therefore, the feedback voltage VFB located at the first terminal of the phototransistor TP may be charged to a lower second voltage level. Therefore, the primary side controller 222 provides the control signal SC having the second switching frequency F2 in response to the feedback voltage VFB having the second voltage level. The primary side controller 222 controls the power switch Q1 using the control signal SC having the second switching frequency F2. Therefore, the power conversion circuit 210 converts the input power VIN into the second output power VO2.

In addition, the primary side controller 222 will receive the sensing voltage value VS located at the second terminal of the power switch Q1. The sensing voltage value VS will be related to the state of the second output power VO2. The primary side controller 222 will fine-tune the second switching frequency F2 and/or the duty cycle of the control signal SC according to the sensing voltage value VS.

In this embodiment, the determining circuit 2231 is implemented by a comparator or an analog-to-digital converter (ADC), for example. The optical coupling circuit 221 is implemented by, for example, the optical coupling element PC817.

In this embodiment, the capacitor CC is coupled between the output terminal of the secondary side circuit 212 and the ground terminal corresponding to the secondary side circuit 212, but the disclosure is not limited thereto. In some embodiments, the capacitor CC may be omitted.

To sum up, when the power adapter does not receive the power requirement of the electronic device, the control circuit of the power adapter reduces the switching frequency to control the power switch in the power conversion circuit. Therefore, when the power requirement of the electronic device is not received, the switching energy loss in the switching state of the power switch may be significantly reduced. In this way, when no power requirement is received, the power adapter may effectively reduce power consumption while continuously providing output power.

Although the present disclosure has been disclosed above through embodiments, it is not intended to limit the present disclosure. Anyone with ordinary knowledge in the technical field can make some modifications and refinement without departing from the spirit and scope of the present disclosure, so the protection scope of the present disclosure shall be determined by the appended claims.

What is claimed is:

1. A power adapter for supplying a power to an electronic device, comprising:
a power conversion circuit receiving an input power, wherein the power conversion circuit comprises a power switch; and
a control circuit coupled to the power conversion circuit, and configured to communicate with the electronic device to obtain a power requirement of the electronic device, wherein
when the electronic device is connected to the power adapter and the electronic device sends the power requirement, the control circuit uses a first switching frequency to control the power switch so that the power conversion circuit converts the input power into a first output power, and
when the power requirement from the electronic device is not received, the control circuit uses a second switching frequency to control the power switch so that the power conversion circuit converts the input power into a second output power,
wherein the second switching frequency is lower than the first switching frequency.

2. The power adapter according to claim 1, wherein when the electronic device is connected to the power adapter and the electronic device is in a normal state, the control circuit uses the first switching frequency to control the power switch so that the power conversion circuit converts the input power converted to the first output power.

3. The power adapter according to claim 1, wherein when the electronic device is connected to the power adapter and the electronic device is in a sleep state, the control circuit uses the second switching frequency to control the power switch so that the power conversion circuit converts the input power into the second output power.

4. The power adapter according to claim 1, wherein when the electronic device is connected to the power adapter and/or a battery of the electronic device is in a fully charged state, the control circuit uses the second switching frequency to control the power switch so that the power conversion circuit convert the input power to the second output power.

5. The power adapter according to claim 1, wherein when the electronic device is not connected to the power adapter, the control circuit uses the second switching frequency to control the power switch so that the power conversion circuit converts the input power into the second output power.

6. The power adapter according to claim 1, wherein:
a voltage waveform of the first output power has a first voltage ripple,
a voltage waveform of the second output power has a second voltage ripple, and
a fluctuation of the second voltage ripple is greater than a fluctuation of the first voltage ripple.

7. The power adapter according to claim 6, wherein
voltage values of the first output power and the second output power are regulated between a high standard voltage value and a low standard voltage value,
a set peak value of the second voltage ripple is lower than the high standard voltage value and higher than a peak value of the first voltage ripple, and
a set valley value of the second voltage ripple is higher than the low standard voltage value and lower than a valley value of the first voltage ripple.

8. The power adapter according to claim 7, wherein
the control circuit receives the second output power,
when the voltage value of the second output power rises to the set peak value, the control circuit controls the power switch to be in a first switching state, and
when the voltage value of the second output power drops to the set valley value, the control circuit controls the power switch to be in a second switching state opposite to the first switching state.

9. The power adapter according to claim 8, wherein the second switching frequency is associated with the set peak value and the set valley value.

10. The power adapter according to claim 7, wherein the power conversion circuit further comprises:
a transformer comprising a primary side winding and a secondary side winding;
a primary side circuit coupled to the primary winding and comprising the power switch; and
a secondary side circuit coupled to the secondary side winding.

11. The power adapter according to claim 10, wherein the control circuit comprises:
an optical coupling circuit controlled to provide an optical signal and provide an operating current according to the optical signal;
a secondary side controller coupled to the secondary side circuit and the optical coupling circuit, and configured to control the optical signal provided by the optical coupling circuit according to the voltage value of one of the first output power and the second output power; and
a primary side controller coupled to the power switch and the optical coupling circuit, and configured to control the power switch according to the operating current.

12. The power adapter according to claim 11, wherein the secondary side controller comprises:
a determining circuit configured to provide an operating signal based on a load status of the power adapter; and
a control switch, wherein a first terminal of the control switch is coupled to the optical coupling circuit, a second terminal of the control switch is coupled to a reference low voltage, and a control terminal of the control switch receives the operating signal.

13. The power adapter according to claim 12, wherein:
when a load of the power adapter is greater than or equal to a predetermined load, the determining circuit uses the operating signal to control the optical coupling circuit to provide the operating current having a first operating current value, and
the primary side controller uses the first switching frequency to control the power switch in response to the first operating current value.

14. The power adapter according to claim 12, wherein:
when a load of the power adapter is less than a predetermined load, the determining circuit uses the operating signal to control the optical coupling circuit to provide the operating current having a second operating current value, and
the primary side controller uses the second switching frequency to control the power switch in response to the second operating current value.
